(19) United States
(12) Patent Application Publication
(10) Pub. No.: US 2018/0372093 A1
(43) Pub. Date: Dec. 27, 2018

(54) WATER PUMP

(71) Applicant: O.M.P. OFFICINE MAZZOCCO PAGNONI S.R.L., FUNO (BO) (IT)

(72) Inventors: Giuseppe LO BIUNDO, FUNO (BO) (IT); Francesco PALLANTE, FUNO (BO) (IT)

(21) Appl. No.: 16/018,769

(22) Filed: Jun. 26, 2018

(30) Foreign Application Priority Data
Jun. 27, 2017 (IT) 102017000071507

(51) Int. Cl. F04C 2/344

(52) U.S. Cl. CPC F04C 2/3442; F04C 2240/10; F01P 5/10; F05C 2203/0808; F04C 2240/802

(57) ABSTRACT

A water pump with a stator, a chamber defined inside the stator, a ring arranged inside said chamber having a radially outer surface in contact with a radially inner surface of the stator, and a rotor arranged inside the ring and rotatable around a rotation axis. The rotor has a plurality of vanes movable along respective radial directions and having respective radially outer ends in contact with a radially inner surface of the ring. The ring is made of a material having a friction coefficient lower than friction coefficient of metal materials.

### CROSS REFERENCE TO RELATED APPLICATIONS

The present application claims priority to Italian Patent Application No. 102017000071507 filed on Jun. 27, 2017, which is incorporated herein by reference in its entirety.

### FIELD

The present disclosure relates to a water pump. Preferably, said water pump is used in the automotive sector, in particular in a cooling circuit of an internal combustion engine. The disclosure also relates to a cooling circuit of an internal combustion engine comprising said water pump.

Reference will be made below in particular to a gasoline or diesel internal combustion engine of a motor vehicle, it being understood, however, that what is said applies more in general also to internal combustion engines of a different type and for other types of vehicles.

The aforementioned water pump may in any case have application in sectors other than the automotive sector, in place of the water pump presently used in those other sectors.

### BACKGROUND

Typically, in order to ensure the correct operation of an internal combustion engine, it is necessary to provide a specific cooling circuit adapted to prevent overheating of the engine.

The cooling circuit typically comprises a water pump, generally driven in rotation by the engine shaft. Such a pump is associated with engine cooling conduits, which generally comprise cavities made in the engine casing, in particular on the walls of the combustion chamber of the engine. Engine cooling takes place through a heat exchange by convection between the engine casing and the cooling water delivered into said cooling conduits by the water pump.

The water pump can also be used to cool other users of the engine, said users being arranged in parallel to the engine. In particular, in the specific case of a gasoline or diesel internal combustion engine, the water delivered by the water pump can also be sent to a heat exchanger in order to condition the oil of the lubrication circuit of the internal combustion engine, whereas in the specific case of a diesel internal combustion engine, the water delivered by the water pump can also be sent to a further heat exchanger to cool the valve for the recirculation of the exhaust gases of the engine.

The water pumps typically used in the cooling circuits of internal combustion engines are centrifugal pumps. These pumps typically comprise a chamber and an impeller housed inside the chamber and adapted to thrust the water, through a respective outlet port, towards the cooling conduits of the internal combustion engine.

### SUMMARY

The Applicant has sought an alternative solution to traditional water pumps and thought to use in the cooling circuits a vane water pump, for example like the ones used in sectors other than the automotive sector.

Such vane water pumps comprise a stator, a chamber defined inside the stator and a rotor rotatable inside said chamber around a rotation axis and provided with a plurality of vanes movable along respective radial directions and in contact with the radially inner surface of the stator.

In order to limit the friction between radially outer ends of the vanes and stator, and consequently the wear on the vanes and of the radially inner surface of the stator, it is known to make the vanes and the stator of carbon graphite.

The Applicant has observed that a drawback of this solution is the excessive cost of the stator.

The Applicant has considered how to overcome said drawback.

The Applicant has realised that this is possible by interposing between the radially outer ends of the vanes and the radially inner surface of the stator a component made of a material having a low friction coefficient.

The present disclosure thus relates, in a first aspect thereof, to a water pump in accordance with the claims.

The water pump comprises a stator, a chamber defined inside the stator and a rotor rotatable inside said chamber around a rotation axis and provided with a plurality of vanes movable along respective radial directions.

The water pump is characterised in that it comprises a ring arranged inside said chamber in a radially outer position with respect to said rotor, wherein said ring has a radially outer surface in contact with a radially inner surface of said stator and a radially inner surface in contact with radially outer ends of said vanes, wherein said ring is made of a material having a friction coefficient lower than the friction coefficient of metal materials.

Advantageously, in the water pump the vanes slide on a component (ring) having a low friction coefficient. This makes it possible to reduce the wear on the vanes and increase the useful life of the water pump.

In a second aspect thereof, the disclosure relates to a cooling circuit of an internal combustion engine comprising said water pump.

Preferred features of the water pump and of the cooling circuit discussed above are disclosed in the dependent claims. Unless expressly ruled out, the features of each dependent claim can be used individually or in combination with the ones disclosed in the other dependent claims.

Preferably, the vanes are made of a non-metal material, such as, for example, carbon graphite or a plastic, thermoplastic or thermosetting, material, with or without fillers or additives.

More preferably, the vanes are made of carbon graphite.

Preferably, the rotor is made of a non-metal material, such as, for example, carbon graphite or a plastic, thermoplastic or thermosetting, material, with or without fillers or additives.

More preferably, the rotor is made of carbon graphite.

Preferably, the ring is made of a non-metal material, such as, for example, carbon graphite or a plastic, thermoplastic or thermosetting, material, with or without fillers or additives.

More preferably, the ring is made of carbon graphite.

Said ring can be integral with (for example planted on or co-moulded with) the stator, i.e. not rotatable with respect to the stator, or rotatable with respect to the latter by virtue of the thrust exerted by the vanes as a result of the rotation of the rotor.

The stator may itself define the outer body of the pump or be a component distinct from the outer body of the pump.

The stator can be made of a metal material, such as, for example, aluminium or alloys thereof, or steel or alloys thereof, or of a non-metal material, such as, for example, carbon graphite or a plastic, thermoplastic or thermosetting material, with or without fillers or additives.

The stator is preferably made of a metal material. This is the case above all when the stator defines the outer body of the pump.

If the ring is rotatable with respect to the stator, making said ring from a material having a friction coefficient lower than the friction coefficient of metal materials makes it possible to contain the friction between the ring and the two surfaces extending perpendicularly to the rotation axis of the rotor and in contact, in a hydraulically sealed manner, with the ring and the vanes.

### BRIEF DESCRIPTION OF THE DRAWINGS

Additional features and advantages of the present disclosure will appear more clearly from the following detailed description of a preferred embodiment thereof, made with reference to the accompanying FIG. 1 and given for indicative and non-limiting purposes.

FIG. 1 schematically shows a cross section of a preferred embodiment of the water pump of the present disclosure.

### DETAILED DESCRIPTION

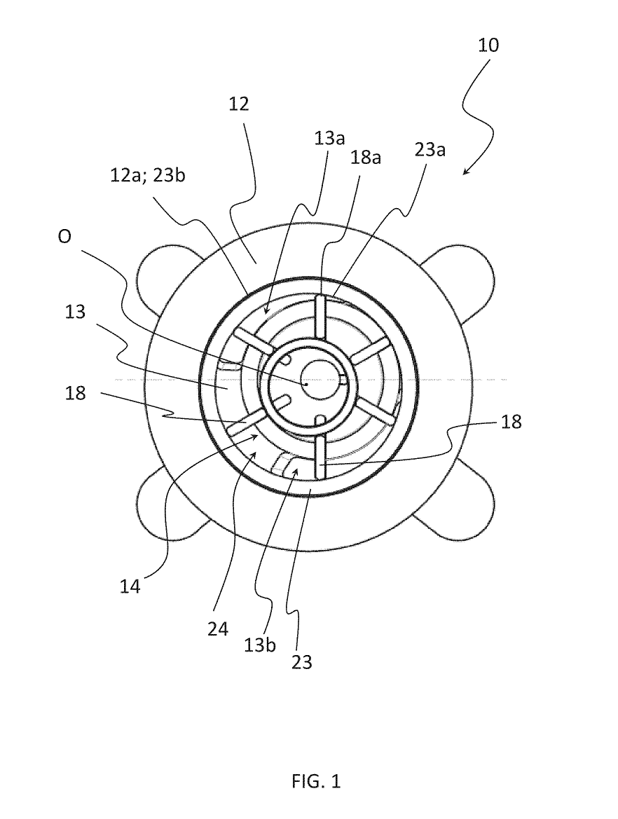

With reference to FIG. 1, it shows a first embodiment of a water pump in accordance with the present disclosure. The water pump is indicated with 10.

The water pump 10 has a fixed displacement (or flow).

The water pump 10 is configured to be used in a cooling circuit of an internal combustion engine for motor vehicles, preferably a gasoline or diesel internal combustion engine,

The pump 10 comprises a stator 12, inside which a chamber 13 is defined.

A rotor 14 is provided inside the chamber 13. The rotor 14 is rotatable around a rotation axis O and is provided with a plurality of radial cavities that slidingly house respective vanes 18. For the sake of clarity of illustration, the numerical reference 18 is associated with only two of the vanes illustrated.

The vanes 18 contact, in a hydraulically sealed manner, two surfaces (not illustrated) perpendicular to the rotation axis O of the rotor 14.

A ring 23 is radially interposed between the stator 12 and the rotor 14. The ring 23 has a radially outer surface 23b in contact with the radially inner surface 12a of the stator 12.

The ring 23 can be integral with the stator 12 or rotatable with respect to the stator 12.

The radially outer ends 18a of the vanes 18 contact, in a hydraulically sealed manner, the radially inner surface 23a of the ring 23. A pressurisation chamber 24 is thus defined between each pair of vanes 18, the ring 23, the rotor 14 and said surfaces perpendicular to the rotation axis O of the rotor 14. For the sake of clarity of illustration, the numerical reference 24 is associated with only one of the pressurisation chambers illustrated.

The stator 12 has a water inlet (or intake) opening 13a which leads into a pressurisation chamber 24 from a suction conduit (not illustrated) and a water outlet (or delivery) opening 13b leading from the pressurisation chamber 24 towards the internal combustion engine and possible heat exchangers provided downstream of the water pump 10.

During the rotation of the rotor 14, the volume inside the pressurisation chambers 24 into which water has been fed through the inlet opening 13a is reduced, thus achieving the desired pressure for feeding the water to the engine cooling circuit through the outlet opening 13b.

The ring 23 is made of a material having a friction coefficient lower than the friction coefficient of metal materials.

Preferably, the ring 23 is made of carbon graphite.

Alternatively, the ring 23 is made of plastic, thermoplastic or thermosetting, materials, with or without fillers or additives.

The ring 23 can be integral with (for example planted on) the stator 12 or rotatable with respect to the latter by virtue of the thrust exerted by the vanes 18 as a result of the rotation of the rotor 14.

The stator 12 can be made of a non-metal material, such as, for example, carbon graphite or a plastic, thermoplastic or thermosetting, material, with or without fillers or additives.

Preferably, the stator 12 is made of a metal material, such as, for example, aluminium or alloys thereof, or steel or alloys thereof.

The vanes 18 and the rotor 14 are made of non-metal materials, preferably carbon graphite or, alternatively, plastic, thermoplastic or thermosetting, materials, with or without fillers or additives.

For the purpose of satisfying specific and contingent needs, a person skilled in the art can make numerous modifications and variants to the water pump 10 described above, all of which being within the scope of protection defined by the following claims.

1. A water pump comprising
a stator,
a chamber defined inside the stator,
a rotor rotatable inside said chamber around a rotation axis and provided with a plurality of vanes movable along respective radial directions, and
a ring arranged inside said chamber in a radially outer position with respect to said rotor,
wherein
said ring has a radially outer surface in contact with a radially inner surface of said stator and a radially inner surface in contact with radially outer ends of said vanes, and
said ring is made of a material having a friction coefficient lower than friction coefficient of metal materials.

2. The water pump according to claim 1, wherein said ring is made of carbon graphite.

3. The water pump according to claim 1, wherein said ring is rotatable with respect to said stator.

4. The water pump according to claim 1, wherein said ring is integral with said stator.

5. The water pump according to claim 1, wherein said stator is made of a metal material.

6. The water pump according to claim 1, wherein said stator is made of a plastic material.

7. The water pump according to claim 1, wherein said vanes and said rotor are made of carbon graphite.

8. A cooling circuit of an internal combustion engine, comprising the water pump according to claim 1.
